(19) United States
(12) Patent Application Publication
(10) Pub. No.: US 2026/0168534 A1
(43) Pub. Date: Jun. 18, 2026

(54) ROLLING BEARING RING UNIT AND METHOD OF PRODUCING A ROLLING BEARING RING UNIT

(71) Applicant: AKTIEBOLAGET SKF, Goteborg (SE)

(72) Inventors: Benoit ARNAULT, Saint-Cyr-sur-Loire (FR); Mickael CHOLLET, Joue-Les-Tours (FR)

(21) Appl. No.: 19/413,077

(22) Filed: Dec. 9, 2025

(30) Foreign Application Priority Data
Dec. 16, 2024 (DE) 102024137839.5

(51) Int. Cl. F16C 33/58

(52) U.S. Cl. CPC F16C 33/585

(57) ABSTRACT

A rolling bearing ring unit includes a bearing outer ring having a raceway and an electrically insulating element fixed to the bearing ring. A first imaginary half-plane extends from the central axis of the bearing ring, and a second imaginary half-plane extends from the central axis and is angularly spaced from the first half-plane. The insulating element is formed such that a distance of any point on a section of the insulating element, which is located between the two half-planes, from the central axis is greater than half of a maximum diameter of the raceway. The bearing ring may be an inner ring with the insulating layer fixed to the inner ring and formed such that a radial distance between the raceway of the inner ring and the central axis is greater than a maximum radius of any point on a section of the insulating element about the central axis.

### CROSS-REFERENCE

This application claims priority to German patent application no. 102024137839.5 filed on Dec. 16, 2024, the contents of which are fully incorporated herein by reference.

### BACKGROUND OF THE INVENTION

The present invention relates to rolling bearings, and more particularly to a rolling bearing ring unit and a method of producing a rolling bearing ring unit.

In particular in electric vehicle applications, electric current flow may damage bearing steel when current passes through a bearing. One known solution is to apply an isolating layer/component on the bearing. Specifically, a deep groove ball bearing is known which includes an isolating layer on an outer ring of the bearing, which is fixed to the radial outer surface of the outer ring. Moreover, the isolating layer is shaped as a hollow cylinder with projections extending radially inwardly at its axial ends.

Further, a bushing may be located at a radially outer surface of the isolating layer. The bushing includes one part or two parts having an L-shape in an axial section. In total, the bushing also has a form of a hollow cylinder with projections extending radially inwardly on both axial ends. The axial ends of the bushing abut against a part of a housing and against a fixation ring.

### SUMMARY OF THE INVENTION

A particular object of the present invention is to provide a longer service life, and a high quality rolling bearing ring unit. This object is achieved by the features of the present invention, which is in an aspect a rolling bearing ring unit comprising at least one outer bearing ring having at least one raceway and a central axis and at least one electrically insulating element fixed to the bearing ring. A first imaginary half-plane extends from the central axis and a second imaginary half-plane extends from the central axis and is angularly spaced from the first half-plane, a section of the insulating element being located between the first half-plane and the second half-plane. The section is sized and formed such that a radial distance between any point on the section of the insulating element and the central axis is greater than half of a maximum diameter of the raceway of the outer bearing ring.

Alternatively, the present invention is a rolling bearing ring unit comprising at least one inner bearing ring having at least one raceway and a central axis and at least one electrically insulating element fixed to the bearing ring. A first imaginary half-plane extends from the central axis and a second imaginary half-plane extends from the central axis and is angularly spaced from the first half-plane, a section of the insulating element being located between the first half-plane and the second half-plane. The section is sized and formed such that a radial distance between the raceway of the inner ring and the central axis is greater than a maximum radius of any point on the section of the insulating element about the central axis.

More specifically, the present invention is a rolling bearing ring unit with at least one bearing ring, which is an outer ring and which comprises at least one raceway, and at least one electrically insulating element, which is fixed to the bearing ring.

It is proposed that there exists a first imaginary half-plane, which is bounded by a central axis of the bearing ring, and a second imaginary half-plane, which is also bounded by the central axis and which is different from the first half-plane, such that a distance of everything of the insulating element, which is located between the half-planes, from the central axis is greater than half of a maximum diameter of the raceway. As used herein, a “distance” of an object from an axis, in particular a minimum of all distances between all geometrical points of the object and the axis is intended to be understood. Also as used herein, the term “half-plane” is intended to mean one of the two regions into which a plane is divided by a straight line which is a part of the plane. The fact that a half-plane is “bounded” by a straight line should be understood to mean in particular that the half-plane is one of the two regions into which a plane is divided by the straight line. The term “central axis” of a bearing ring is intended to mean a straight line in an axial direction of the bearing ring which extends through a center of mass of the bearing ring.

Due to the structure of the present invention, a longer service life and a high-quality rolling bearing ring unit can be provided. In particular, during a process for producing a rolling bearing ring unit, a force exerted by a mold form onto the bearing ring, which can cause damage to the bearing ring and/or the raceway, is avoided.

Moreover, a rolling bearing ring unit with at least one bearing ring, which is an inner ring and which comprises at least one raceway, and at least one electrically insulating element, which is fixed to the bearing ring, is proposed, wherein there exists a first imaginary half-plane, which is bounded by a central axis of the bearing ring, and a second imaginary half-plane, which is also bounded by the central axis and which is different from the first half-plane, such that a distance of the raceway from the central axis is greater than a maximum radius of everything of the insulating element, which is located between the half-planes, measured with respect to the central axis. Through this a high-quality rolling bearing ring unit can be provided.

Preferably, the electrically insulating element is fixed directly to the bearing ring on at least two sides of the bearing ring. Thereby, safe electrical insulation of the bearing ring can be achieved.

Advantageously, the electrically insulating element comprises a radially inner or radially outer surface, which is free from a contact with the bearing ring and which comprises at least one projection. By means of this projection, a simple production of the insulating element can be achieved. Specifically, during a production of the insulating element, injection points for injection molding compound can be located at the projection.

Furthermore, it is suggested that the rolling bearing ring unit comprises at least one bushing, which is fixed to the electrically insulating element and which comprises at least one part. Through this, a good fixation of the bearing ring together with an easy assembly of the bearing ring can be achieved.

In particular, the bushing may consist of two parts having each an L-shape in an axial section. Through this, the rolling bearing ring unit can comprise axial abutment surfaces, which are electrically insulated.

Moreover, it is proposed that the at least two parts of the bushing are identical in construction. Thereby, cost-efficient production can be reached.

Furthermore, a process or method of producing a rolling bearing ring unit, in particular as described above, with at least one bearing ring which is an outer ring and which comprises at least one raceway, is suggested, wherein at least one electrically insulating element is fixed to the bearing ring, wherein the electrically insulating element is molded with a mold form, wherein a part of a radially inner surface of the electrically insulating element touches or contacts a part of a contact surface area of the mold form at least temporarily during the procedure, wherein a distance of the part of the contact surface area from a central axis of the bearing ring is greater than half of a maximum diameter of the raceway. Through this method, a high-quality rolling bearing ring unit can be provided or manufactured. In particular, during the process of producing the bearing, the exertion of a force by a mold form onto the bearing ring is avoided, which can cause damage to the bearing ring and/or the raceway.

Moreover, a process or method of producing a rolling bearing ring unit, in particular as described above, with at least one bearing ring which is an inner ring and which comprises at least one raceway, is proposed, wherein at least one electrically insulating element is fixed to the bearing ring, wherein the electrically insulating element is molded with a mold form, wherein at least a part of a radially outer surface of the electrically insulating element touches a contact surface area of the mold form at least temporarily during the procedure, wherein a distance of the contact surface area from a central axis of the bearing ring is less than a distance of the raceway from the central axis. Through this a high-quality rolling bearing ring unit can be provided. In particular, during the procedure, it can be avoided that the mold form exerts a force onto the bearing ring, which can cause damage to the bearing ring and/or the raceway.

Preferably, injection molding compound is injected into the mold form at least at one point on one side of the bearing ring. Advantageously, the injection molding compound is injected at most at ten points at each face side of the bearing ring. Through the injection of molding compound, the mold form can abut against a large surface region of the face sides of the bearing ring, which have a greater distance from the central axis of the bearing ring than the raceway of the bearing ring in case the bearing ring is an outer ring and which have a lesser distance to the central axis of the bearing ring than the raceway of the bearing ring in case the bearing ring is an inner ring. In particular, it can be avoided that the mold form damages the bearing ring and/or the raceway through a manner and way the mold form abuts against the bearing ring face sides.

### BRIEF DESCRIPTION OF THE SEVERAL VIEWS OF THE DRAWINGS

Further advantages can be seen in the following description of the drawings. Examples of embodiments of the invention are shown in the drawings. The drawings, the description and the claims contain numerous features in combination. The skilled person will expediently also consider the features individually and combine them to form useful further combinations.

FIG. 1 shows a view on a face side of a bearing according to the invention;

FIG. 2A shows an axial section through the bearing according to FIG. 1;

FIG. 2B shows a part of the axial section during a production procedure;

FIG. 3 shows another axial section through the bearing according to FIG. 1;

FIG. 4 shows a view on a further face side of the bearing; and

FIG. 5 shows a part of an axial section through another bearing according to the invention.

### DETAILED DESCRIPTION OF THE INVENTION

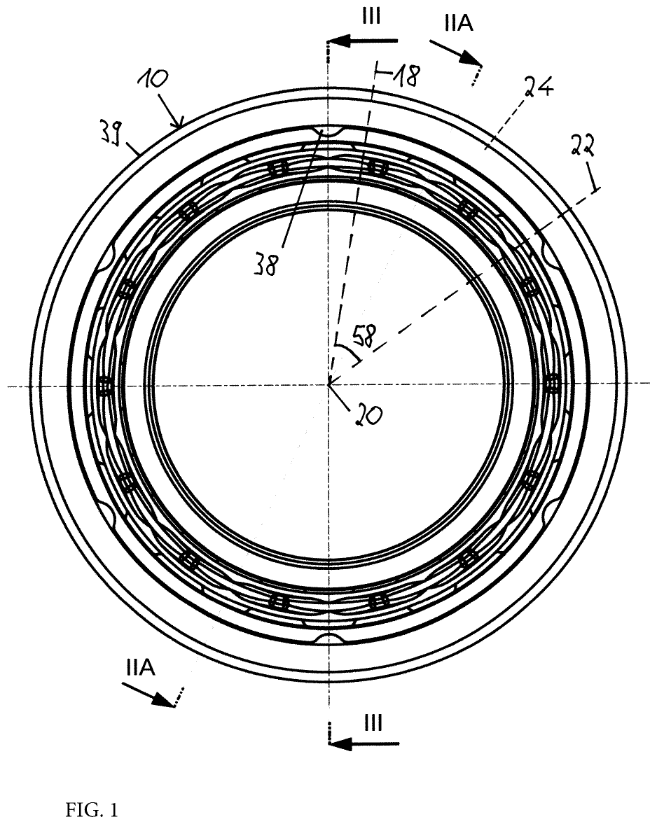

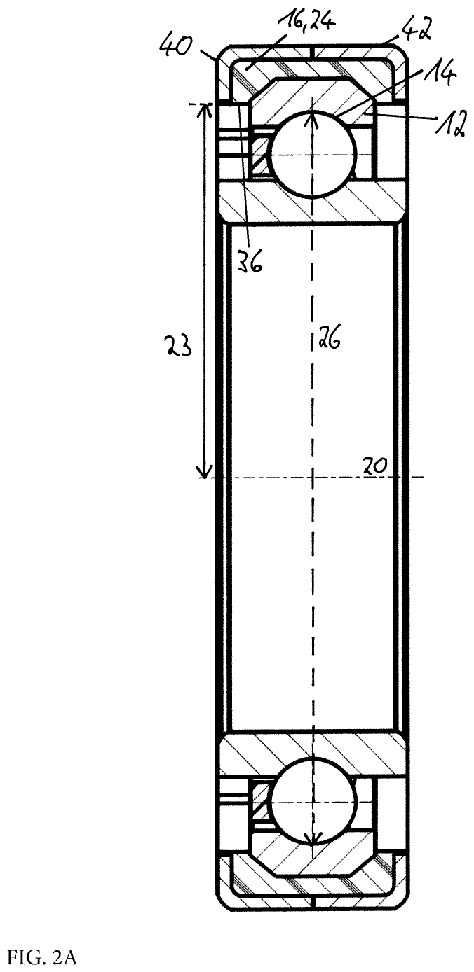

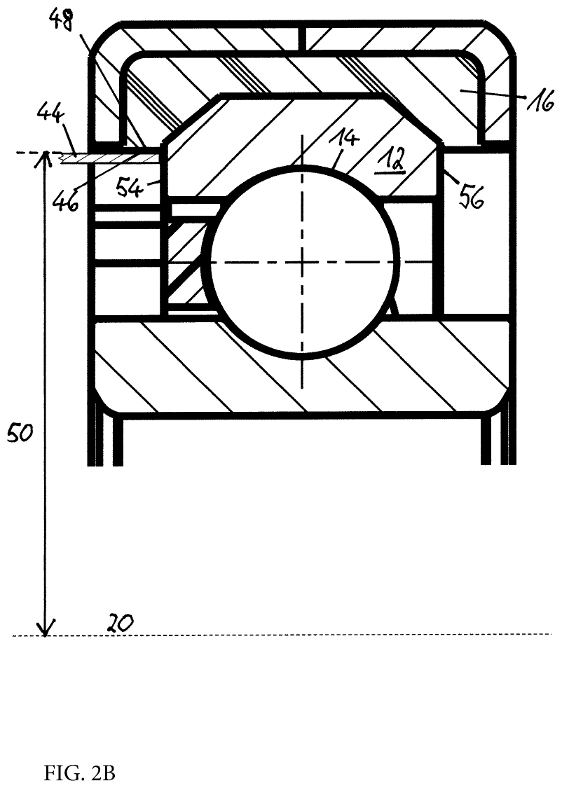

FIG. 1 shows a view on a face side of a bearing, which comprises a rolling bearing ring unit 10 according to the present invention. The rolling bearing ring unit 10 comprises an electrically insulating element 16 and a bearing ring 12 with a raceway 14 (FIG. 2A). In the example illustrated in the drawing figures, the bearing ring 12 that is provided with the electrically insulating element 16 is an outer ring. Alternatively, the bearing ring 12 could be an inner ring. A central axis 20 of the bearing ring 12 extends in an axial direction of the bearing ring 12.

The electrically insulating element 16 is fixed to the bearing ring 12. The insulating element 16 is made of a synthetic material, such as for example, polyetheretherketone (“PEEK”) or polyamide 46 (abbreviated as PA46), an elastomeric material such as a rubber, etc.

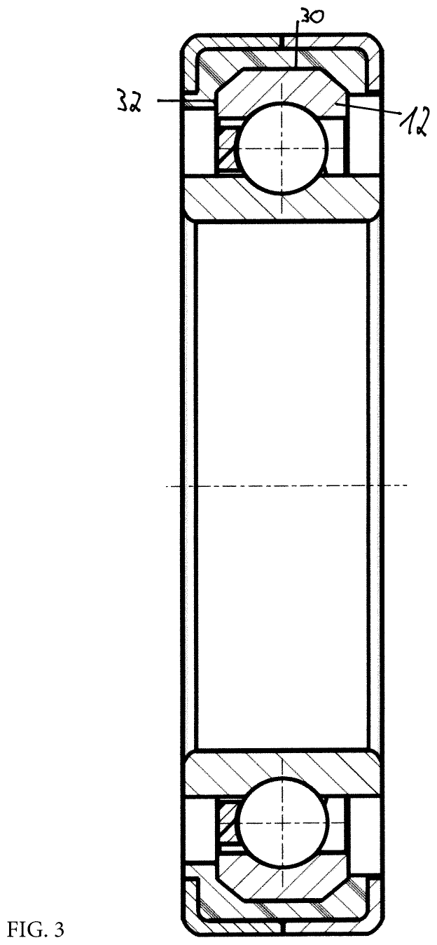

The electrically insulating element 16 is fixed directly to the bearing ring 12 on the outer side 30 of the outer ring 12, and on two front sides 32 of the bearing ring (FIG. 3). Moreover, the electrically insulating element 16 includes a radially inner surface 36 (FIG. 2A), which is free from contact with the bearing ring 12 and which includes at least one and preferably a plurality of projections 38, most preferably six projections 38 as shown in FIG. 1. Alternatively, the electrically insulating element 16 may be provided with less than six projections 38, from one to five, or more than six projections 38. The projections 38 extend radially inwardly. The projections 38 may have any desired and appropriate shape, for example partly circular or rounded as shown in FIG. 1, square-shaped, triangular, etc.

Furthermore, the rolling bearing ring unit 10 preferably also comprises a bushing 39, which is fixed to the electrically insulating element 16 and which consists of two parts 40, 42. The two parts 40, 42 are identical in construction and each of the two parts 40 and 42 is L-shaped in an axial section. Each of the two parts 40, 42 is preferably made of steel and preferably formed of sheet metal by stamping and rolling or machining. Alternatively, the bushing 39 may consist of only a single part (i.e., one-piece construction).

A first imaginary half-plane 18 and a second imaginary half-plane 22 are bounded by and extend from the central axis 20 (FIG. 1). The two half-planes 18, 22 are different or distinct from each other and are angularly spaced apart by an angle 58 that is defined between the two half-planes 18, 22. According to the illustrated embodiment, the angle 58 is preferably smaller than 90° (i.e., an acute angle). A part or section 24 of the insulating element 16 is located or defined between the two half-planes 18, 22. The part/section 24 includes everything of the insulating element 16 that is located between the two half planes 18, 22.

A distance 23 is defined between any point on the section 24 of the insulating element 16 and the central axis 20. According to the present invention, the section 24 is sized and formed such that the distance 23 is greater than half of a maximum diameter 26 of the raceway 14.

Due to the present invention, a radial distance or spacing is defined between an inner end 36 of the section 24 of the insulating element 16 and the bottom of the raceway 14 of the outer ring 12, as best shown in FIG. 2B. This radial distance/spacing enables the application of an improved molding process to the bearing ring 12 when molding the electrically insulating material 16 onto the bearing ring 12.

In a process or method for producing the rolling bearing ring unit 10, the electrically insulating element 16 is fixed to the bearing ring 12 by molding with a mold form 44 (FIG. 2B). A part 46 of a radially inner surface of the electrically insulating element 16 touches a part 48 of a contact surface area of the mold form 44 during the molding process. A distance 50 of the part 48 of the contact surface area of the mold form 44 from the central axis 20 of the bearing ring 12 is greater than half of a maximum diameter 26 of the raceway 14. During the molding process, the mold form 44 applies a force directly on the bearing ring 12 in an axial direction at a region of the bearing ring 12, which is primarily or entirely radially above the raceway 14. Therefore the raceway 14 and the bearing ring 12 are not damaged by the force applied by the mold form 44. The mold form 44 applies the force to the bearing ring 12 because injection molding compound, through which the electrically insulating element 16 is created, is prevented from flowing through a gap between the bearing ring 12 and the mold form 44.

The injection molding compound is injected into the mold form 44 preferably at six points at a face side 54 of the bearing ring 12. On the second face side 56 of the bearing ring 12, no injection takes place. At each one of the mold injection points, one of the projections 38 is created or formed, as shown in FIG. 1.

The bushing 39 provides a relatively large axial contact surface area. Moreover, the bushing 29 is preferably fixed to the bearing ring 12 during the molding.

The bearing may be used, for example, to rotatably support a shaft in an electric motor (not shown). The motor may be a part of an electric vehicle. Due to the use of the electrically insulating element 16, a flow of electric current through the bearing is avoided or prevented.

An advantage of the electrically insulating element 16 is that it has a relatively low material volume and a low mass.

The molding process is performed with known conditions.

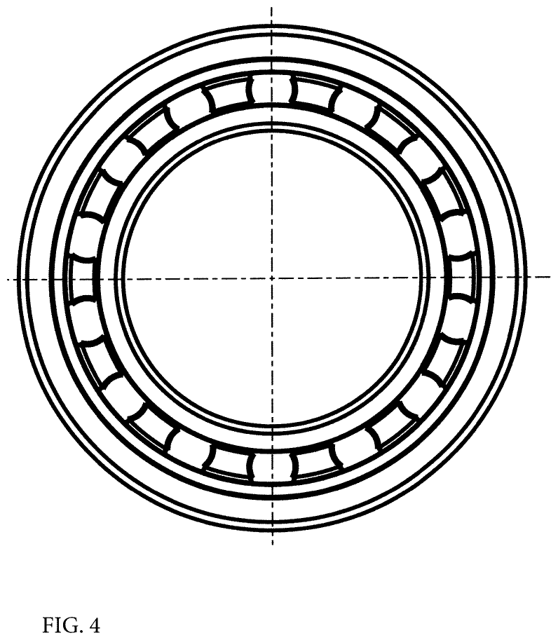

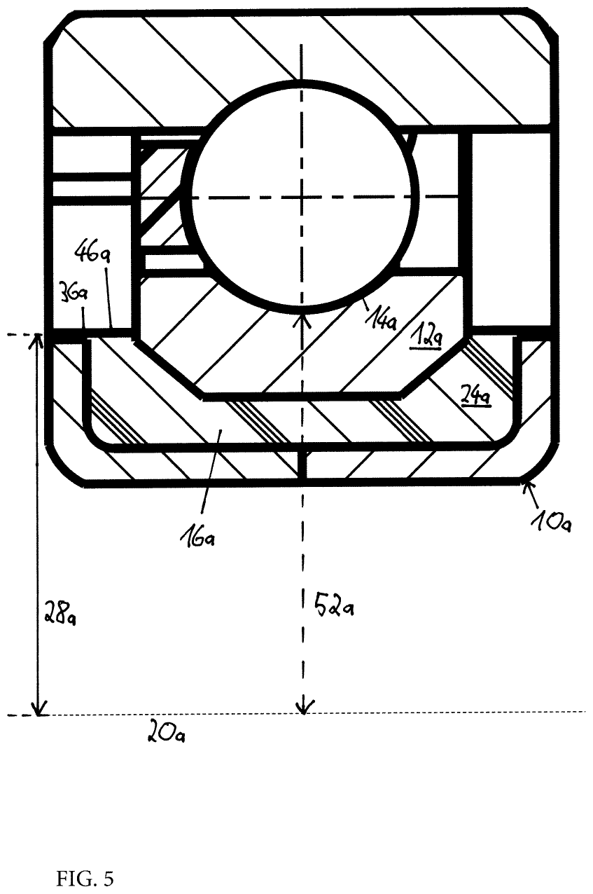

FIG. 5 shows an alternative embodiment. Components, features and functions that are essentially the same are generally numbered with the same reference signs. However, the letter “a” has been added to the reference signs of the embodiment in FIG. 5 to differentiate between the embodiments. The following description is essentially limited to the differences to the embodiment of FIGS. 1-4, whereby reference can be made to the description of the embodiment in FIGS. 1-4 with regard to components, features and functions that remain the same.

FIG. 5 shows a rolling bearing ring unit 10a with a bearing ring 12a, which is an inner ring. A part or section 24a of an electrically insulating element 16a is located between two half-planes, as described for the first embodiment. The part/section 24a of the insulating element 16a is everything (i.e., all parts or portions) of the insulating element 16a that is located between the two half-planes. A distance of a raceway 14a from a central axis 20a is greater than a maximum radius 28a of any part of the section 24a measured with respect to the central axis 20a.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

List of reference numerals:

| | |
|---|---|
| 10 | rolling bearing ring unit |
| 12 | bearing ring |
| 14 | raceway |
| 16 | insulating element |
| 18 | half-plane |
| 20 | central axis |
| 22 | half-plane |
| 23 | distance |
| 24 | part |
| 26 | diameter |
| 28 | radius |
| 30 | side |
| 32 | side |
| 36 | surface |
| 38 | projection |
| 39 | bushing |
| 40 | part |
| 42 | part |
| 44 | mold form |
| 46 | part |
| 48 | part |
| 50 | distance |
| 52 | distance |
| 54 | face side |
| 56 | face side |
| 58 | angle |

We claim:

1. A rolling bearing ring unit comprising:
at least one outer bearing ring having at least one raceway and a central axis; and
at least one electrically insulating element fixed to the bearing ring;
wherein a first imaginary half-plane extends from the central axis and a second imaginary half-plane extends from the central axis and is angularly spaced from the first half-plane, a section of the insulating element located between the first half-plane and the second half-plane being sized and formed such that a radial distance between any point on the section of the insulating element and the central axis is greater than half of a maximum diameter of the raceway of the outer bearing ring.

2. The rolling bearing ring unit according to claim 1, wherein the electrically insulating element is fixed directly to the outer bearing ring on at least two sides of the bearing ring.

3. The rolling bearing ring unit according to claim 1, wherein the electrically insulating element includes a radially inner surface which is free from contact with the bearing outer ring and includes at least one projection.

4. The rolling bearing ring unit according to claim 1, further comprising at least one bushing fixed to the electrically insulating element and including at least one part.

5. The rolling bearing ring unit according to claim 4, wherein the bushing includes two parts, each one of the two parts being L-shaped in an axial section.

6. A rolling bearing with at least one rolling bearing ring unit according to claim 1.

7. A rolling bearing ring unit comprising:
at least one inner bearing ring having at least one raceway and a central axis; and
at least one electrically insulating element fixed to the bearing ring;
wherein a first imaginary half-plane extends from the central axis and a second imaginary half-plane extends from the central axis and is angularly spaced from the first half-plane, a section of the insulating element located between the first half-plane and the second half-plane being sized and formed such that a radial distance between the raceway of the inner ring and the central axis is greater than a maximum radius of any point on the section of the insulating element about the central axis.

8. The rolling bearing ring unit according to claim 7, wherein the electrically insulating element is fixed directly to the inner bearing ring on at least two sides of the bearing ring.

9. The rolling bearing ring unit according to claim 7, wherein the electrically insulating element includes a radially outer surface which is free from contact with the inner bearing ring and includes at least one projection.

10. The rolling bearing ring unit according to claim 7, further comprising at least one bushing fixed to the electrically insulating element and including at least one part.

11. The rolling bearing ring unit according to claim 10, wherein the bushing includes two parts, each one of the two parts being L-shaped in an axial section.

12. A rolling bearing with at least one rolling bearing ring unit according to claim 7.

13. A method of producing a rolling bearing ring unit comprising the steps of:
providing at least one bearing outer ring having at least one raceway; and
molding at least one electrically insulating element to the at least one bearing outer ring with a mold form such that a part of a radially inner surface of the electrically insulating element touches a part of a contact surface area of the mold form at least temporarily during molding;
wherein a distance of the part of the contact surface area from a central axis of the bearing outer ring is greater than half of a maximum diameter of the raceway.

14. The method according to claim 13, further comprising a step of injecting injection molding compound into the mold form at no more than ten points at each face side of the bearing outer ring.

15. A method of producing a rolling bearing ring unit comprising the steps of:
providing at least one bearing inner ring having at least one raceway; and
molding at least one electrically insulating element to the at least one bearing inner ring with a mold form such that a part of a radially outer surface of the electrically insulating element touches a part of a contact surface area of the mold form at least temporarily during molding;
wherein a distance of the part of the contact surface area from a central axis of the bearing inner ring is less than a distance of the raceway from the central axis.

16. The method according to claim 15, further comprising a step of injecting injection molding compound into the mold form at no more than ten points at each face side of the bearing inner ring.
